(19) United States
(12) Patent Application Publication
(10) Pub. No.: US 2009/0187826 A1
(43) Pub. Date: Jul. 23, 2009

(54) DATA CONTROL AND DISPLAY SYSTEM

(75) Inventors: Andrew D. Heimbold, Los Angeles, CA (US); Steven B. Heimbold, Los Angeles, CA (US)

Correspondence Address: STEPTOE & JOHNSON LLP, 2121 AVENUE OF THE STARS, SUITE 2800, LOS ANGELES, CA, 90067, US

(73) Assignee: REALITY CHECK STUDIOS INC., Los Angeles, CA (US)

(21) Appl. No.: 12/358,165

(22) Filed: Jan. 22, 2009

Related U.S. Application Data
(60) Provisional application No. 61/062,044, filed on Jan. 22, 2008.

(51) Int. Cl. G06F 3/00; H04N 5/04

(52) U.S. Cl. 715/719; 348/500; 348/E05.009

(57) ABSTRACT

A system and method for controlling the production of data including a control layer having a computer and a user interface that enables an operator to control the production of data. The system and method also includes a content layer in communication with the control layer. The control layer can access video and graphical data from the content layer. A processing layer is in communication with the control layer and the content layer, such that the processing layer is able to process the video and graphical data from the content layer upon the command of the control layer. There is also a delivery layer in communication with the control layer and the processing layer, such that the delivery layer delivers the final output of the video and graphical data upon the command of the control layer.

### CROSS-REFERENCE TO RELATED APPLICATIONS

This application claims the benefit of Provisional Patent Application No. 61/062,044, filed Jan. 22, 2008, which is hereby incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE EMBODIMENTS

This description relates to a system for controlling data and, more specifically, to a system for producing media.

### REFERENCE TO COMPUTER PROGRAM LISTING

A computer program listing of a computer program constructed and operative in accordance with one embodiment of the present disclosure is enclosed on an electronic medium in computer readable form and is hereby incorporated by reference. The computer program listing is contained in one file, the name, size and creation date of which is as follows: computer program.txt (129 KB, Jan. 22, 2009). This listing is not meant to be all-inclusive as the disclosed embodiments allow for the design of an unlimited number of computer programs that can be run via numerous computer applications and on the computing platform(s) of the disclosed embodiments.

### BACKGROUND

Live television technology began with analog TV signals having no graphics and has now moved to digital broadcasts in high definition (“HD”). This technology is used to broadcast sporting and news events live, or in real-time, by transmitting a video and/or audio signal of the event via a video and/or audio media while the event itself is taking place. Originally, network studios handled the remote productions of events until production truck companies were formed and took over the production using traditional video technology. One production truck, which may include a fifty-three foot trailer, has to be capable of supporting multiple networks. The technology systems used by the production trucks also had to be flexible, which means that the production trucks have to be adequately equipped for all networks and production styles. These multi-million dollar production trucks typically contain equipment for editing video and/or audio signals and producing a television program. The trucks also include a wall of several video monitors for displaying the output of the various cameras and other video feeds. The production truck also includes a video and audio mixer, a switcher for combining and switching between the different video and audio signals of the event, and video and audio synchronizing equipment.

A diverse team is needed to manage the production system on the production truck, including a director and several engineers. Each engineer controls one of the various equipment devices and functions on the production truck, including the video and audio switchers, video sources, replay, commercials, promotional events, sponsorship, pre-produced graphics, audio devices, insertion of graphics, and any other content required for the production of the television program. Specialized training is needed for the engineers to operate every device on the production truck, which increases labor costs.

Modern day television broadcasts have become very complex and expensive, especially with the transition to full HD broadcasts. Further, with new technologies, new advertising models (including captive commercials for Web 2.0 delivery), and rising costs, television networks are demanding an alternative that produces broadcast content more efficiently.

The current production truck model of producing a television broadcast has several drawbacks. Production trucks are not agile and cannot change quickly with new demands, due largely to the fact that the production truck companies have invested in antiquated technology. Use of this technology is costly due to the cost of the equipment inside the truck or trailer and the labor costs to operate this equipment. Further, production trucks are costly and inefficient due to rising fuel prices, the required electrical requirements on site, and the weight of the production trucks exceeds road limits, resulting in fines and environmental impacts.

These high costs primarily only allow major networks and TV stations to produce live television programming using this technology. Also, the high costs justify broadcasting larger professional sporting events with the production truck technology, and not producing smaller or local events with the production truck technology.

Therefore, what is needed is an improved paradigm for producing live television programs that is more efficient, less costly, simpler to produce, and capable of changing and adapting to new demands of different broadcasts.

### SUMMARY

Briefly, and in general terms, the present disclosure is directed towards an embodiment of a system for controlling the production of data. The system includes a control layer associated with a computer and a user interface that enables an operator to control the production of data. There is also a content layer in communication with the control layer. The content layer may include modules for providing video and/or graphical data, so that the control layer can access the video and graphical data. A processing layer is included in the system and is in communication with the control layer and the content layer. The processing layer processes the video and graphical data stored in the content layer upon the command of the control layer. This embodiment also includes a delivery layer in communication with the control layer and processing layer. The delivery layer delivers the final output of the video and graphical data upon the command of the control layer. In this embodiment, the data control system synchronizes and controls disparate devices located in the content layer and the processing layer. In one embodiment, the graphic data is template based.

In one embodiment, the system also includes a communication layer or network in communication with and located between the control layer, content layer, processing layer and delivery layer. The communication layer provides a conduit or path for the control layer to access the devices of the content layer. The communication layer may also be in communication with one or more servers, and/or an external communications link.

In one embodiment, the processing layer may include a video router and/or a video switcher. The processing layer may also include an audio mixer and/or an audio router.

In use, one embodiment of the data control system provides sources of video and graphical content to a centralized control device. The system synchronizes the video and graphical content with a processing device, and then delivers the video and graphical content through a final video output for production into a live broadcast. In this embodiment, the system controls the synchronizing of the video and graphical content via a centralized control system that is in communication with the video and graphical content, the processing device, and the video output.

The various systems may use video and graphical content provided from live camera feeds, pre-produced graphic templates, or any other data source. Also, live data may also be synchronized with the video and graphical content in one embodiment. It is contemplated that a local language feed may be provided to the control system, and the system may then synchronize the local language feed with the video and graphical data.

Other aspects and features of the various embodiments will become apparent from the following detailed description when taken in conjunction with the accompanying drawings, which illustrate, by way of example, the features of the various embodiments.

### BRIEF DESCRIPTION OF THE DRAWINGS

FIG. 1 depicts a schematic layout of one embodiment of a data control system.

FIG. 1A depicts another embodiment of a data control system.

FIG. 2A depicts one embodiment of a video switching user interface control customized for a NASCAR race.

FIG. 2B depicts one embodiment of a graphics control user interface customized for a NASCAR race.

FIGS. 3A through 3K depict multiple screen layouts for one embodiment of the data control and display system.

FIG. 4A depicts one embodiment of a video user interface control.

FIG. 4B depicts one embodiment of a graphics user interface control.

FIG. 4C depicts one embodiment of a consolidated video and graphics user interface control.

FIG. 5 depicts a hierarchy of organization in the creation of template scenes in the data control system, in which elements are organized under a main category.

### DETAILED DESCRIPTION

Various embodiments of a data control system described below incorporate a change in the priority of managing the different independent systems. In broadcast television today, there is very little communication between the different hardware devices, because these devices have been built upon antiquated video standards rather than modern computing technologies. Rather than spend time integrating these devices together in a peer-to-peer approach, the data control system takes a monolithic approach and uses custom software to control all of these devices from centralized computer-based control systems. Instead of separate machines doing individual tasks as in the production truck model, the system employs a centralized control system that automates much of the typical production responsibilities. This system makes all of the video devices slaves of a master control computer. Since the system is software based, many of the repetitive operations used during a live broadcast can be choreographed.

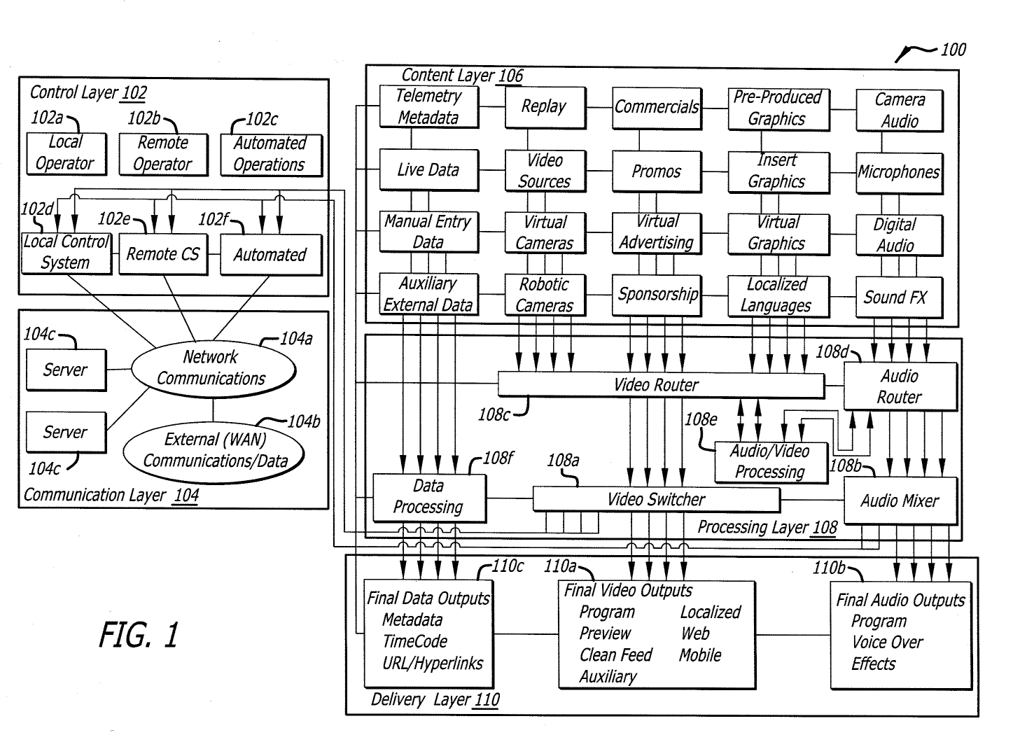

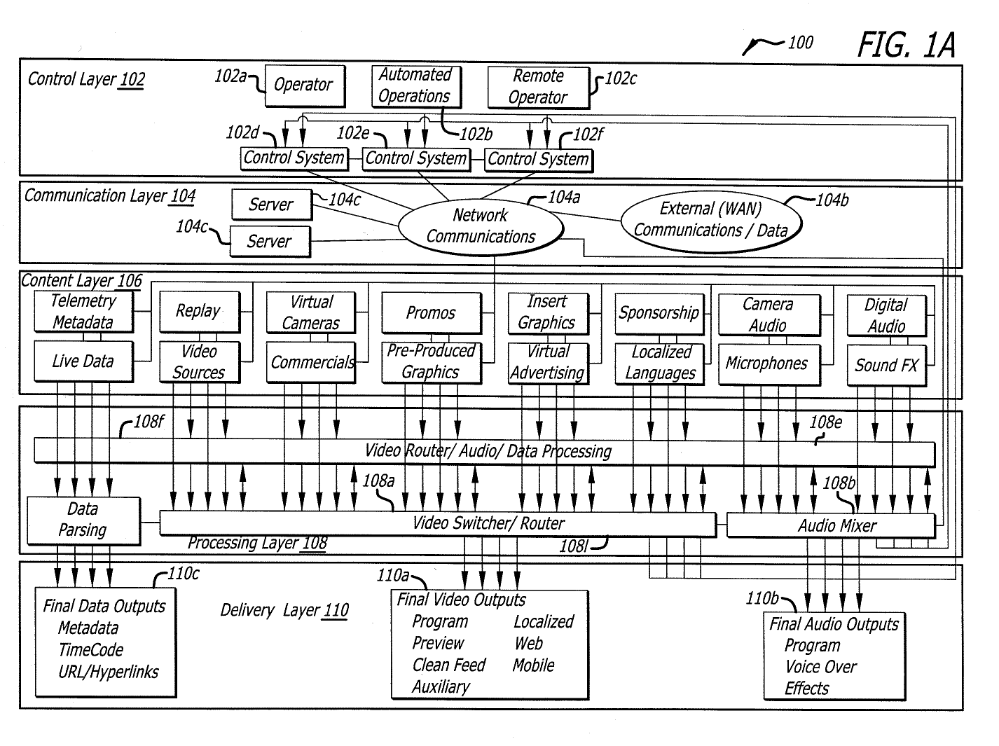

Referring now to the drawings, wherein like reference numerals denote like or corresponding parts throughout the drawings and, more particularly to FIGS. 1 through 5, there are shown various embodiments of a system for controlling and displaying data. More specifically, as shown in FIG. 1, a data control system 100 reprioritizes the operation control responsibilities in a live broadcast environment. There are five layers in the workflow methodology of this embodiment, including the control layer 102, communication layer 104, content layer 106, processing layer 108, and delivery layer 110. These five layers also represent the order in which the system executes commands in one embodiment. Another layout of the data control system 100a is shown in FIG. 1A. The five layers 102 through 110 in the workflow methodology are still present in FIG. 1A.

As shown in FIG. 1, the data control system 100 represents a fundamental change in the approach to modern broadcasting. Instead of numerous disparate devices each with a limited scope of functionality, the system 100 consolidates much of the required functionality, which increases the flexibility and redundancy in the system.

The flexibility of the data control system 100 is due to a computer based front-end control application. By centralizing and automating many of the routing tasks, the capabilities that traditional broadcasters achieve are matched with less people, less equipment, and ultimately, less cost while achieving the same, or greater level of broadcast production value.

Traditional broadcast systems have become extremely complex due to the rapidly changing requirements of the networks. Vendors are rapidly updating their individual systems to compete in this marketplace without consideration for the overall direction of the market. The data control system 100 can provide a smaller footprint system that requires less people and labor to manage. By integrating graphics and video production into a custom application, this embodiment focuses on the required functionality needed to produce a broadcast.

I. Terminology
Master Scene Template (MST)—A term used by applicants to describe the real-time graphic template in a broadcast. The MST can include many various elements depicted in FIG. 1, including virtual cameras, robotic cameras, commercials, promos, virtual advertising, sponsorship, pre-produced graphics, insert graphics, virtual graphics, localized languages, digital audio, and sound FX.
Auxiliary Feeds—Additional outputs on a switcher. Auxiliary feeds are typically used to provide a slightly different broadcast feed for other applications (Web 2.0, international, and the like).
Switcher—A device used to produce typical broadcasts. A switcher can select incoming video sources and perform basic manipulations of this video. This includes crossfades, video cuts, transitions, repositioning of the video, and other various functionality based on the type of switcher.
Router—A device used to route various input video signals (sources) to specified output locations (destinations).
Digital Disk Recorder (DDR)—A computer dedicated to playing digital video directly off the hard drive.
HD—HD stands for high definition, which refers to the various formats of digital television. Typical HD broadcast formats are 1080i and 720p.
SDI—SDI stands for serial digital interface, which is the digital format of a video signal. Typically used with the resolution format (i.e., HD SDI 1080i).
MIDP—MIDP stands for multi image display processor, which is a device that can take in multiple video feeds and combine them onto a single video signal. Typically used for viewing multiple video signals on a single monitor.
Insert Graphics—Insert graphics are used during a broadcast that typically incorporates some type of live text or information, i.e., ticker, scoreboard, and the like.
Pre-Produced Graphics—Graphics that are built in advance of the broadcast. Generally these graphics cannot be modified in real-time.
Full Screen Graphic—A graphic element that takes up most of the display area on a typical monitor. An example of this would be full screen image of Stock Market data.
Lower Third Graphic—A graphic element that generally resides in the bottom of the screen and takes up no more than 33% of the screen area. An example of this would be a graphic that shows the name of the person currently speaking.
Over the Shoulder Graphic (OTS)—A graphic element that appears to the right side or left side of an On-Air talent. This graphic is typically used to reinforce the topic that the On-Air talent is speaking about.

II. One Embodiment of the Data Control System

Current live broadcasts revolve around a switcher. Switchers are able to take in numerous video steams (including graphics) and perform all of the routing and transitions of video sources needed to produce a broadcast. As a central hub of a broadcast all of the secondary video devices (replay, graphics, promos, opens, sponsors, and highlights) must coordinate activities to provide a seamless broadcast. Much of this coordination is done orally via a team of highly-trained operators.

The data control system 100 uses a computer in combination with a custom application to produce a broadcast. More specifically, the system provides a platform for controlling various disparate systems from a central computer. The system can achieve a much higher level of speed and accuracy than is currently used by manual operations in live broadcasts of today.

A. Workflow

By incorporating a monolithic approach to the devices, the described embodiments are able to synchronize and choreograph a series of complex options that are required in modern broadcast. Instead of using teams of highly-trained personnel using oral queues, the embodiment of the data control system relies on high speed computer systems. These computers provide an easier control metaphor for the operators. Functional responsibilities are able to be combined and/or distributed as needed to achieve the most efficient workflow by using a modular approach to the software development.

Traditional video productions rely on a Technical Director (“TD”) to control the switcher which serves as the central hub of a broadcast. An operator not only controls the video switching, but any other devices required during the broadcast. Switchers typically are not designed to support high-speed, two-way communication. Instead, switchers usually incorporate low-end Serial (RS 242, RS 422) and GPI (General Purpose Interface) interfaces to control other devices. One embodiment of the data control system 100 relies on TCP/IP control for speed and flexibility, but can also control any device that has an external interface, including Serial and GPI.

B. Graphics

One embodiment of the data control system 100 closely integrates with “template based” graphics systems, initially developed to accommodate the need for a system that can dynamically put up changing information over a live broadcast. Typical examples are a ticker during a news broadcast, a clock, or a score element of a sporting event.

Other graphic aspects of a modern broadcast such as Opening Animations, Transitions, and Bumpers are typically created using raster-based technology. This involves rendering hundreds of frames of sequential animation and playing the linear sequence back from a video source (typically a DDR or Tape deck). One embodiment of the data control system 100 can incorporate all types of graphic elements seamlessly into the template-based system. This provides a consistent platform for the integration of the graphics. Other graphics that are incorporated into the system may include insert elements (e.g., live data driven graphics); open, closes, bumps, and teases (based on graphics templates or pre-rendered); background animation; tickers; sponsorship; and transitions.

Much of the ability to incorporate so many of the graphics elements in this embodiment is based upon the real-time 3D rendering technology. Open GL and DirectX are both hardware-based libraries that accelerate the processing of graphics in a real-time environment.

One embodiment of the data control system 100 incorporates highly-optimized, custom graphics into one or more systems to achieve the same results as modern broadcasters. The system shown in FIG. 1 can also combine the functionality of the devices responsible for commercials, promos, virtual advertising, sponsorship, pre-produced graphics, insert graphics, virtual graphics, and localized languages into a single device.

C. Software

The data control system 100 of the current embodiment is a computer system running custom software developed in an object-oriented language. One embodiment of the custom software was submitted with the application as computer program.txt (129 KB, Jan. 22, 2009). The software application was developed in an object oriented development language. In one embodiment, for use with HotPass HD, the system uses Borland C++ but any other languages can be used as well. The software functionality is built into modules that can be combined to build the necessary functionality in a broadcast. This custom software is one embodiment of a computer program that will allow the creation of libraries of code and functionality required to control the various components needed during a broadcast. As those of ordinary skill in the art realize, other embodiments of computer programs can be created to accomplish the same task.

Broadcast technology must accommodate numerous uses since the devices have become extremely complicated. Therefore, a typical video switcher may be used for many different purposes and needs to have the flexibility for many diverse uses. This embodiment of the data control system 100 has identified the core features needed in a typical broadcast, and instead of using a switcher control panel, this system uses software to access the functionality.

Using software, the current embodiment is able to build a much more flexible system. This embodiment of the system focuses on the core features required during a broadcast. Functionality is built into modules of code that can be distributed to various machines as needed. This allows the operators, such as a local operator 102a, a remote operator 102b, and/or an automated operations operator 102c to group related functionality as needed based on the television production and capability of the staff.

One embodiment of the data control system 100 distributes the operational responsibilities of a broadcast based on two criteria: (1) the functional requirements of the system, and (2) the operational responsibilities of the operator.

The operations can be combined or distributed as necessary to accommodate the specific adaptation of the system. A simple adaptation could consolidate all video, graphics and promotional needs on a single system. A more complex system may separate video and graphics operations while using an automated system for sponsor requirements. With this approach, a user can easily combine and distribute operational responsibilities as needed.

Several types of modules can be included in the system. The different types of video modules include video switching, live cameras, virtual cameras, robotic cameras, replay systems, graphics overlay, transitions, sponsorship overlays, commercial advertising, and multiple languages graphics and audio. Types of audio modules may include audio mixing/automation, camera audio, commentator/microphone audio, audio FX, voice over, sample box, auxiliary video productions, and simulcasts. Also, different types of data modules may include global positioning system (GPS) data, metadata tagging, statistics, timecode, hyperlinks, and hot spots.

D. Distributed Systems

As new technologies have been introduced to broadcasts (replay, commercial insertion, virtual advertising, tickers, and the like.), these systems are typically created by various vendors with little or no consideration on how to integrate them in a live broadcast. Many of these systems include generic Serial or GPI interfaces for inter-device control, but many of the protocols are limited.

Many new devices incorporate a TCP/IP interface. Depending on how robust the vendors simple network management protocol (“SNMP”) stack is developed allows inter-device communication. Typically, even with IP capabilities, many of these devices are not made for two way communication, rather, simple command triggers based on internal rules. The data control system 100 incorporates much more sophisticated algorithms to control multiple devices in a highly-synchronized format.

E. Sporting Event Embodiment

In one embodiment, the data control system 100 as shown in FIG. 1 can be used to produce a live sporting event, such as a NASCAR event. In this embodiment, the data control system may utilize an approximately 8′×8′ space on a broadcast production truck or other space. The hardware for five full Standard Definition broadcasts and one backup system in the event of hardware failure is provided in this space. In another embodiment, the event may be broadcast in full High Definition. Typical networks will utilize one or two 55′ production trucks per broadcast. The data control system of this embodiment is able to produce multiple channels in a fraction of the space currently used by the production trucks. In one embodiment, such as the broadcast for HotPass on DIRECTV, the data control system may control separate channels that are driver specific, where each channel broadcast is devoted to a single driver in the NASCAR event. In another embodiment, there can be several data control systems at the event that would each control a separate channel.

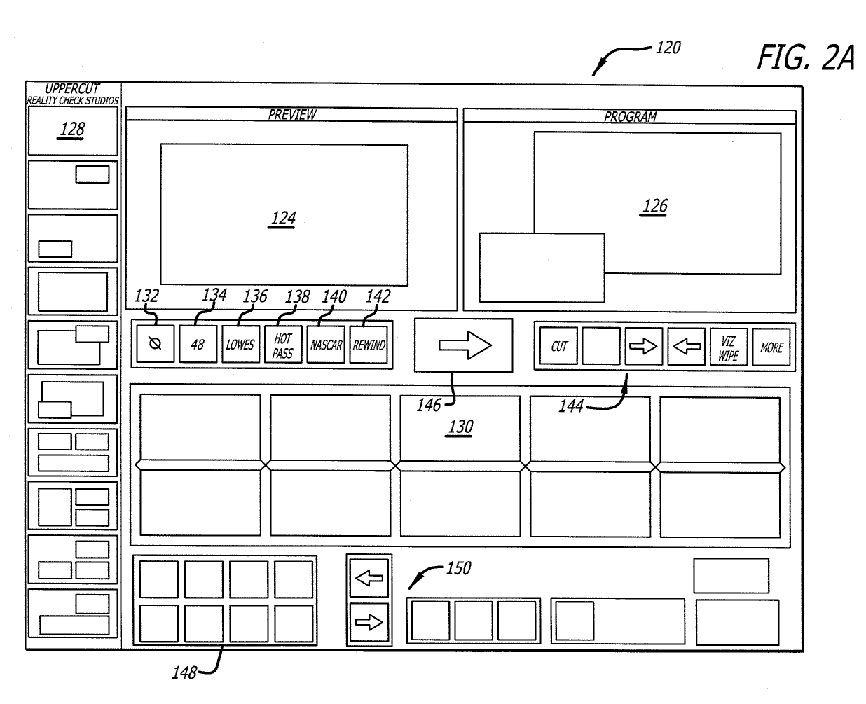

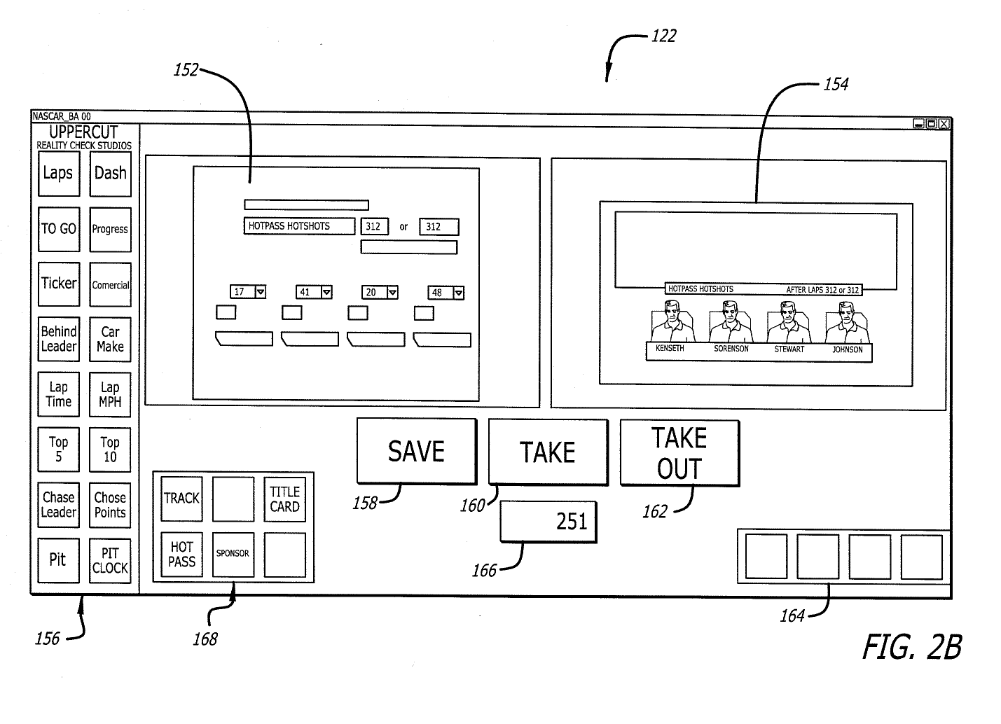

The software used with the data control system 100 can be adapted to control the specific functionality required by the event. In this embodiment, the software can be modified to produce a NASCAR event for a network or television station. This allows the controls to be greatly simplified for the operators, and greatly reduces the training time for the operators and allows them to take on additional responsibilities during the broadcast. For this embodiment, the operators for the data control system can handle the video switching and graphics overlay portion, or the operators can handle all of the aspects required for a live broadcast. In this system, there is a video user interface 120 shown in FIG. 2A, and a graphics user interface control 122 shown in FIG. 2B. The video and graphical controls are touch-screens, but may include any type of input device. Also, both the video and graphics controls 120 and 122 shown in FIGS. 2A and 2B are custom for a NASCAR event in this embodiment. For other events, the user interface controls can be customized to those sports or programs. It has also been contemplated that the video and graphics controls 120 and 122 could be positioned on a single screen.

As shown in FIG. 2A, the video controller 120 includes a preview window 124, showing a preview of what the operator has called up on the screen, and a program window 126, showing the video and graphical content that is currently on-air. On the left side of the screen is a screen layout 128 bar, allowing the operator to easily switch between different types of screen layouts. In this embodiment, there are ten camera feeds 130 displayed on the screen, and the operator can easily switch between which camera will be live and on-air. This customized version includes a full screen transition row of buttons including a cut button 132, a driver button 134, a sponsor button 136, HotPass button 138, NASCAR button 140, and a replay button 142.

Touching any of these buttons will provide a full screen transition at the direction of the operator. There is also a row of window transition buttons 144 that will provide a transition in one window of the screen, which can include multiple video windows. A take button 146 is also provided and is used to bring the preview screen 124 up onto the program screen 126. Preset buttons 148 are also provided and allow the operator to save a selected layout and video feed. Repositioning buttons 150 move the video up/down or right/left to properly frame the video feed. For other events, certain buttons, such as the HotPass button 138 will be replaced with another customized button. Also, the positioning of the windows and buttons on the screen of the video controller 120 can be changed as desired. Other features or buttons can also be provided on the user interface screen that enables the operator to produce a broadcast.

Referring now to FIG. 2B, the graphics user interface control 122 allows an operator to control the graphics that will be placed on the screen simultaneously with the video feeds. A user entry screen 152 allows the operator to enter data. As shown, this system includes a template with hooks for data to be entered into. A program screen 154 is also on the graphic control screen showing the video and graphical content that is currently on-air. On the left of the screen there is a quick toolbar of preset buttons 156 used to turn certain pre-set graphical information on/off. For example, the operator can turn on the Laps button to display the current number of laps driven in a race. The preset buttons 156 are customized to whatever event is being broadcast. There is also a save function 158 to save templates created by the operator that can be called back up at a later time. A take button 160 is also provided and is used to bring the user entry screen up onto the program screen. A take-out button 162 removes the graphical content currently on-air. In the NASCAR embodiment, there are flag toggles 164 so the operator can send to the screen the current conditions on the race track. There is also a template entry 166 where a template code can be entered to bring up a specific scene template on the user entry screen. Preset buttons 168 are shown in FIG. 2B and are so positioned because they do not fit within the quick toolbar 156. Additional features can also be added to the graphic user interface control as desired, and the location of the buttons can also be changed in other embodiments. In one embodiment the additional features can be added in real-time.

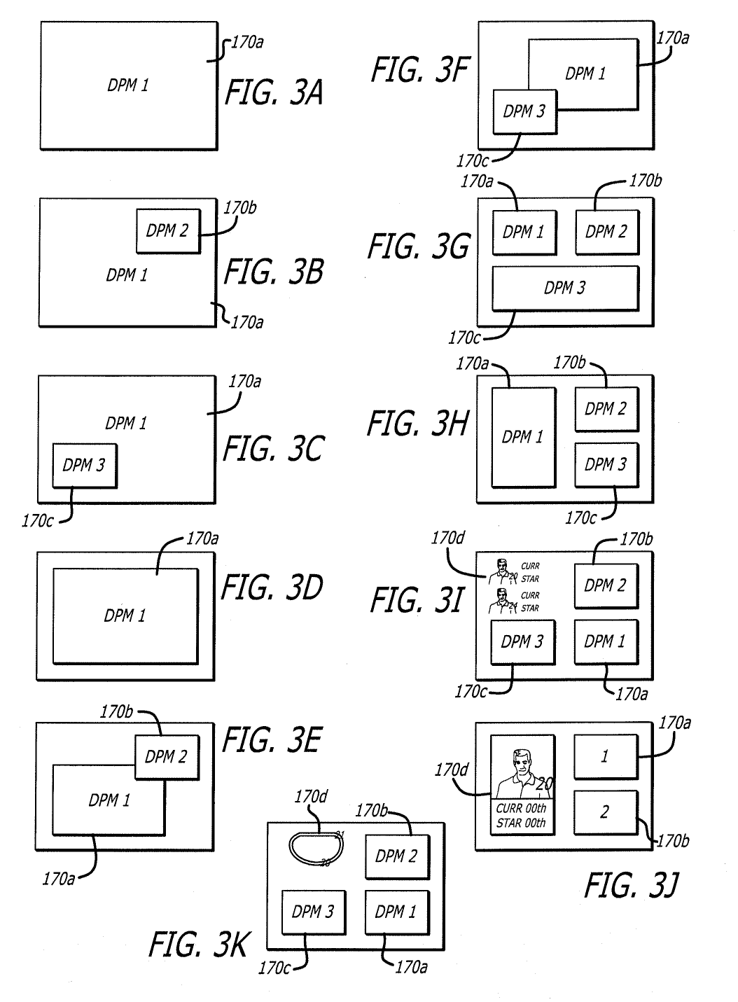

Possible video layouts are disclosed in FIGS. 3A through 3K. The windows 170a through 170d on the screens shown in FIGS. 3A through 3K can include any type of information/data, such as video sources, live data, graphics, animations and the like, that the user wishes to broadcast. As shown in FIGS. 3A through 3K, the windows 170a through 170d can vary in size, shape, and location on the screen. Further additional windows may be added to the screen as required by the broadcast. These layouts illustrate possible positions of the video windows in the switcher. Coordinates are then referenced by the operator through software for configuring the layouts from the computer, which uses a different coordinate system. The layout and information/data provided in a scene is controlled by the operators using the video controller 120 and graphics user interface 124.

In one embodiment, external control commands from VizRT are used to send data and configure a scene. These external control commands can be found starting on page 166 of the viz|artist 2.7 User Manual, which is hereby incorporated by reference in its entirety. However, those skilled in the art will appreciate that other software packages may also be used, such as Chryon's HyperX2 (http://www.chyron.com/products/graphicsystems/hyperx2.aspx), Brainstorm (http://www.brainstorm.es/pages/onair3d.php), or Orad (http://www.orad.tv/). In one embodiment, specific commands for the VizRT platform are used by artists to build the graphic scenes in the different layouts for HotPass and denote the variable “hooks” for the engineer to populate via software.

Possible scenes for the screen layout are template-based and include video windows, such as two top windows and a bottom window. The video windows can be in any arrangement or size as desired to show multiple video feeds. In certain embodiments, there may be a background scene, graphics covering any portion of the screen, such as a lower one-third graphics, lower one-half graphics, a sponsorship area, and a ticker running on any portion of the screen. Telemetry data can be inserted into the various elements on the screen. The final output can also include virtual representation of events in graphics formed in a separate window. In one embodiment, a virtual track can be placed in one window with virtual cars and drivers shown in position on the track in real-time. Those skilled in the art will realize that other virtual representations of any event can be used. Scene embodiments may also include full-page transitions, sponsor wipes, full-screen graphics template, generic image templates, window specific events, and window-specific transitions instead of full screen transitions. Of course, these screen layouts can be adjusted and rearranged as desired or required. The attributes of the scene, such as color, event data such as driver's number, and other data information can be immediately inserted into the template since the scene is template based.

In one embodiment, the screen layouts are choreographed before the broadcast. However, it has been contemplated that the screen layouts can be more flexible and changed in real-time during the broadcast. This would allow one operator to create a screen for a situation that arises as the event is occurring and was not choreographed before the event.

It is to be understood that the personnel required to produced other events or shows will vary depending on the requirements for the specific broadcast. However, in this NASCAR embodiment, each channel for the broadcast should require the following personnel to control each aspect of the broadcast:
A Technical Director (TD) who uses the video switching portion of the data control system 100. There is one TD per channel, but it is possible to have more TDs per channel.
A Broadcast Associate (BA) who creates all the graphics and tracks the status of the NASCAR race or other event or production. There is one BA per channel, but it is possible to have more than one BA.
A Channel Producer who researches the driver and coordinates with the talent to create a story about the driver. There is one channel producer per channel.
An Audio Mixer who mixes the audio levels from the various sources. There is one audio mixer per channel.
A Replay Operator who tracks all the highlights throughout the races or other event and makes the sources for the production. There is one relay operator per channel.
Camera Operators to operate cameras and show the NASCAR race or other event or production. Typically there are three to four operators per channel, but there can be any number of camera operators as required or desired.
A Show Producer who oversees the production for all of the channels. There is typically one show producer for the entire production.
A Coordinating Producer who assists the Show Producer. Typically there is one coordinating producer for the entire production.

III. Construction of One Embodiment

Traditional video production puts the switcher at the center of the operations. Switchers have limited functionality in inter-device communication. By controlling a switcher from a computer running the custom software disclosed herein, the data control system 100 is able to synchronize commands to the switcher and other devices. The operator is not limited to the subset of functionality on a switcher, but rather, can control any device via the computer.

The control of the data control system 100 is based on software running off standard computers. Libraries of code are created to communicate with the various devices. Each of the protocols requires a library that allows the computer system to control the various devices.

Traditional switchers are very expensive and difficult to use, because they must be flexible devices to accommodate any type of broadcast such as news, sports, corporate events, studio programming, and the like. A typical event will only use a small percent of the functionality of a switcher; however, an operator must be very skilled to effectively access that small percent of functionality, which changes based on the application. The data control system's 100 front-end control system is customized for the necessary application. By focusing on the necessary functionality required to produce a live show, this embodiment of the data control system is able to simplify the operation of the broadcasting system. Additionally, this embodiment is able to increase the efficiency of the operation by automating many of the repetitive tasks.

One embodiment of the data control system 100 incorporates a touch screen panel to select the various video and graphical sources and layouts as shown in FIGS. 2A and 2B. This is not required, and user interface can be operated with a mouse and keyboard or any other input device as needed.

Since the primary control of the data control system 100 is computer-based, it is easy to divide up production responsibilities among multiple operators each on their own computer. The switching of the video feed can be on one system while the graphics overlay can be accomplished on a different system. Additional functionality can be split out or combined based on the requirements of the production. All of the computer code is built so the system can easily be configured as needed.

A. Workflow Methodology

As previously described, one embodiment of the data control system 100 reprioritizes the workflow in a typical broadcast environment to achieve a simplified control metaphor, based on a five-layer methodology as shown in FIG. 1. High-speed networking is used to centralize control of these devices via custom software control.

1. Control Layer

The control layer 102 puts a local operator 102a, remote operator 102b, and/or an automated operations operator 102c in control of control systems 102d, 102e, and 102f, respectively, which are in communication with and control all the various hardware devices. Instead of individual operators controlling specialized hardware each with a custom interface, a common software based user interface is utilized to access the hardware. There can be any amount of operators and control systems depending on the requirements of the broadcast, including just one operator working at one control system. Also, there can be any number of content-delivery devices and redundancy, due to the modular approach of the system.

The local operator 102a can be any personnel using the data control system's user interface. The system can work in an automated mode without any operators or with any amount of operators needed to effectively operate the required modules for the broadcast production. Additionally, the operator does not have to be on site and can control the system remotely as well. The local control system 102d can be any number of control computers running custom software modules for the broadcast.

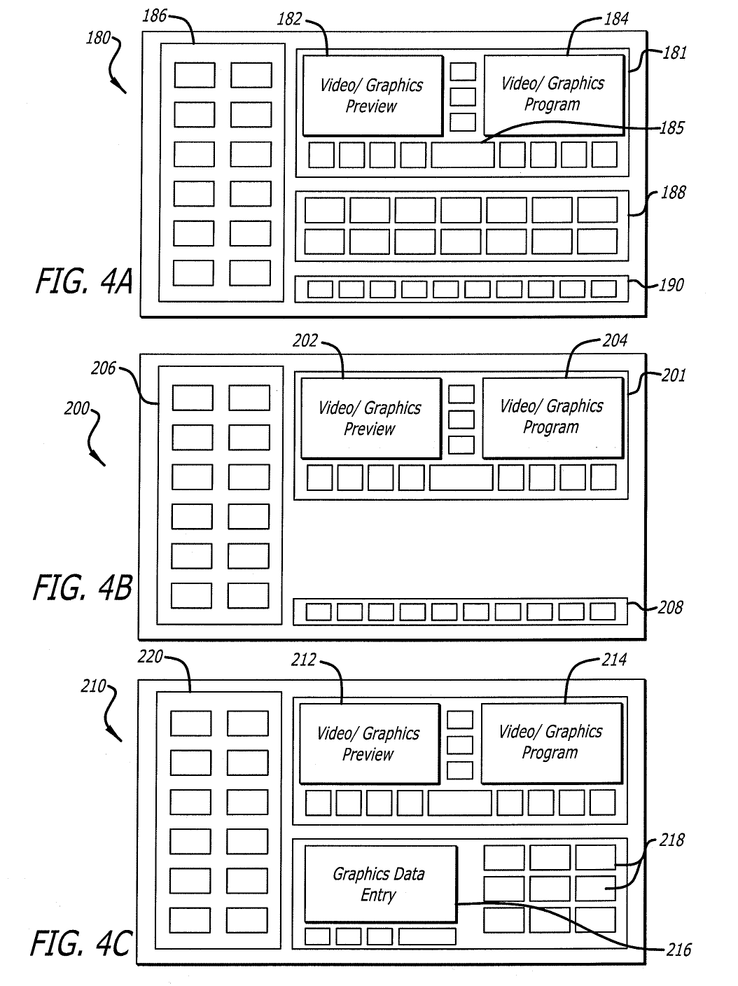

As previously described, one embodiment of the user interfaces for the operators is shown in FIGS. 2A and 2B. A more general video user interface 180 is shown in FIG. 4A and includes a video control area 181. The video control area 181 includes a preview window 182, showing a preview of what the operator has called up on the screen, and a program window 184, showing the video and graphical content that is currently on-air. Additional buttons are also found in the video control area for editing and producing the video content. For instance, a full screen transition row of buttons can be included, and also included can be a row of window transition buttons that will provide a transition in one window of the screen, which can include multiple video windows. A take button 185 can also be provided and is used to bring the preview screen 182 up onto the program screen 184. On the left side of the screen is a preset layout bar 186, allowing the operator to easily switch between screen layouts. In this embodiment, there are fourteen camera feeds 188 displayed on the screen for monitoring, and the operator can easily switch between the camera feeds to put on-air. It has been contemplated that fewer or more than fourteen cameras can be monitored on the user interface. Preset buttons 190 are also provide and allow the operator to save a selected layout and video feed. Other features or buttons can also be provided on the user interface screen that enables the operator to produce a broadcast.

Referring now to FIG. 4B, a graphics user interface control 200 allows an operator to control the graphics that will be placed on the screen simultaneously with the video feeds. A graphics entry area 201 includes a graphics data entry screen 202 and allows the operator to enter data into specific fields. A program screen 204 is also on the graphic control screen showing the video and graphical content that is currently on-air. On the left of the screen there is a quick toolbar of preset buttons 206 used to turn certain pre-set graphical information on/off. Preset buttons 208 are shown in FIG. 4B and allow the operator to preset certain graphical data within a template. Additional features can also be added to the graphic user interface control 200. In one embodiment, the additional features can be added in real-time.

In one embodiment, a consolidated video/graphics user interface 210 can be used as shown in FIG. 4C. This consolidated user interface includes a video/graphics preview screen 212 and a video/graphics program screen 214. There is also a graphics data entry screen 216 to allow data to be entered into specific fields. Camera feeds can be monitored on the camera windows 218, and this embodiment discloses nine camera feeds. Also, the consolidated user interface can include a preset toolbar 220. Any feature disclosed in the separate video user interface and graphics user interface can be positioned on the consolidated user interface screen for use by an operator.

The computers used in the control systems 102d, 102e, and/or 102f are standard personal computers (“PC's”). Most modern desktop and server class computers provide enough performance to manage the embodiment of the data control system 100. There can be any number of computer control systems used depending on the requirements of the broadcast. With the modular approach to software development, this system can combine or separate the various functionality as needed. Any current Microsoft, Apple, UNIX, or other operating system can be used as long as the system can support a programming environment and all the required communication protocols and basic device drivers for operation.

In one embodiment, three types of control systems may be used during operations. As shown in FIG. 1, the local control system 102d is performed by an operator located near the primary operations. There can also be a remote control system 102e controlled from a remote site. This could be within the venue gathering statistics to a remote location moderating a chat panel. Also, it is possible to have an automated control system 102f driven via software triggers and algorithms. It has also been contemplated that any number of control systems could be used, including one control system to control the entire system. Another embodiment of the data control system 100a is shown in FIG. 1A.

Network connectivity is required for device control. Additional serial connectivity may be required based on the requirements of the hardware used on layers 106, 108 and 110 of the system. Network and Serial are both typical interfaces on most computers. Additional control interfaces such as GPI (General Purpose Interface) and others can be added as needed through expansion cards.

The computers are controlled via a custom user interface (“UI”), such as the custom UI shown in FIGS. 2A and 2B. The user can control this via any input devices or combinations thereof, including a mouse and keyboard, touch screen, multi-touch screen (recognizes multiple simultaneous inputs), custom keypads, custom LCD touch pads, jog and shuttle knobs, game controllers, joysticks, pointers, remote controls, audio mixing board, and/or video mixing board.

The control computers require a standard video card capable of driving a standard display for the UI. Multi-head cards (multiple display outputs) are supported as needed for functionality. The display can also be a standard definition (“SD”) or high definition (“HD”) video signal if needed.

In one embodiment the software UI is also capable of displaying both the source video feeds as well as the program feed. To overlay multiple video feeds directly on the UI, a MIDP (Multi Image Display Processor) may be incorporated to support a background computer layer. The UI output from the control computer was looped through the MID,P and the video sources were composited on top of the UI. This allows the system to overlay up to 12 discreet video sources with an Evertz VIP 12 (Model 7767VIP12). The composite signal is then passed onto the control monitor via a DVI-D cable. The video overlay is not needed in every application and depends on the availability of monitors to preview the video sources.

The computer used to render the graphics needs to be a high-performance workstation. Typically, these machines have higher clock speeds, faster busses, more RAM, faster Hard Drives and faster video cards. In one embodiment the data control system 100 uses the NVidia Quadro FX line of graphics cards ranging from the 4000 to the 5600 models. Other graphic acceleration card manufacturers can also be used, such as ATI. It is also important that the video system supports the proper output video format. The output video formats are typically SD SDI (Standard Definition Serial Digital Interface) or HD SDI (High Definition Serial Digital Interface). They can also be any computer format at various resolutions (VGA, XGA, SXGA, UXGA, WXGA, WSXGA, WUXGA, and DVI-D) or any other formats that are required by the system. An additional Video I/O card can be used as well for video input. In one embodiment, a Matrox X.mio 8000 video input/output card PCI-X 133 MHz is used. Other video I/O cards can be used as long as they are compatible with the system. An audio card can also be incorporated into the system to supply the graphics with sound effects. There are numerous manufacturers that support the various formats required. Typical output formats for audio are balanced audio (analog) in either stereo or mono, and AES (Audio Engineering Society) for digital formats.

The graphics engine typically incorporates one or more hard drives that can be configured in a RAID (Redundant Array of Inexpensive Drives) format for higher performance. Any current Microsoft, Apple, UNIX, or other operating systems can be used as long they support the graphics program used for the template graphics as well as the necessary drivers for the video acceleration cards.

Live broadcasts generally incorporate some type of display methodology to view all the various audio/video/graphics feeds. Typical production trucks and control rooms will use a monitor wall to display each feed on a separate monitor. MIDP (Multi Image Display Processors) can also be used to consolidate many feeds onto a single monitor. In one embodiment, the data control system 100 can be used for HotPass HD on DIRECTV and utilize a 12 input MIDP (Evertz 7767VIP12) to display 10 source feeds in addition to a preview and program feed. This can best be seen in FIG. 2A.

Although not shown, there can also be an audio user interface for an operator to control audio during a broadcast. The functions of an audio user interface can also be consolidated into the video user interface.

A graphics user interface can be seen in FIG. 2B or 4B. The graphics user interface can be consolidated with the video user interface as shown in FIG. 4C, and this consolidated unit could also include the functionality of an audio user interface.

2. Communication Layer

The communication layer 104 is a network that connects the control layer 102 to the content layer 106 as well as to the processing layer 108. The communication layer can support any of the standardized protocols that are being used today.

Typical communication utilizes TCP/IP (Transmission Control Protocol/Internet Protocol) or UDP (User Datagram Protocol) over standard Category5, 5e or 6 twisted pair cable, but any other protocols/interfaces can be used including VTR's (BVW-75), AMP, Luth VDCP, Odetics, Tally Systems, Routing control systems (Trinix, Venus, Triton, Jupiter, Encore). With the control layer 102 able to communicate with any device in the pipeline, it becomes much easier to coordinate actions between disparate devices. Protocols are implemented within the data control system 100 production environment via custom libraries or dll files stored in memory.

The communication layer 104 may include a network communication 104a to allow the local control system 102d to communicate with any device or server in the pipeline. There may also be an external (WAN) communications/data 104b for third party vendors providing real-time stats for professional sports events or bloggers. The external communications portal can also use any third party to provide any information needed for a broadcast of any event or production. Servers 104c can also be a part of the communication layer 104. The servers 104c work in a standard capacity providing any/all of the following information, including statistics, graphic assets (headshots, logos, sponsors, and the like), graphic template(s) which may be used on the graphics engine, and the like. There can be any number of servers based on the type of information required for the broadcast.

3. Content Layer

The content layer 106 refers to any device or module that contributes information to a broadcast. The control layer 102 can access the content layer 106 via the communication layer 104. Modules in the content layer may include any of the following: telemetry metadata, live data, manual entry data, auxiliary external data (i.e., cell phones, web, chat, blogs, RSS feeds, and the like), video sources, robotic cameras, virtual cameras (i.e., video game virtual cameras), RF (radio frequency) cameras, recorded video sources, replay video sources, promos, advertising, commercials, teases, sponsorship, virtual advertising insertion, insert graphics, rendered graphics (i.e., opens, bumps, closes), transitions, pre-produced graphics, localized languages, backgrounds, live audio, pre-recorded audio, audio sound effects, statistical server, database, telemetry information, GPS data, and/or camera information (position, angle, zoom).

Camera feeds and microphones supply some of the content-from-content layer 106. For other types of content found in the content layer 106, a memory storage device may be used to store the information. Digital Disk Recorders (“DDR”) are one device that may be used to store the information. DDR's are devices used to play digitized content in a live broadcast environment and may be one of the devices located in the content layer 106 of the data control system 100. DDR's are based on stored files on a computer-based system, and therefore, the content can be easily accessed in a non-linear format. The capacity of a DDR is based upon its total amount of storage as well as the format being used to output the graphics. DDR's can also provide multiple streams of video simultaneously. This can be helpful in matching a Key and Fill channel of a graphic element. DDR's can be used to provide content during a broadcast including replays, commercials, highlights, promotional elements or promos, audio, any pre-recorded video content, such as, Interviews, Athlete profile, Story segments, and any pre-produced graphics, such as, opens, closes, bumpers, backgrounds, and transitions.

In one embodiment, the use for these types of applications is to play the digitized content directly back from within the Graphics Engine. Again, this allows not only the consolidated approach to controlling the discreet functionality, but also greatly increases the ability to synchronize the operation commands. An example of this would be letting the operator do a template transition from a live video source to a recorded highlight segment. While this can be done currently, this example relies on separate devices working in parallel.

In some cases it may not be possible to integrate all digitized content into the data control system 100. In those situations, the data control system can work with dedicated external DDR's (Grass Valley iDDR/Profile, EVS XT[2], Digital Rapids CarbonHD, Doremi MCS) with software integration (where supported by the manufacturer) or in a standalone format with or without a dedicated operator.

4. Processing Layer

The processing layer 108 is in communication with and combines the sources from the content layer 106 to produce the final broadcast using a video switcher 108a and audio mixer 108b. As shown in FIG. 1, there may also be a video router 108c and an audio router 108d that are in communication with the video switcher and audio mixer, respectively. The control of the video switcher 108a and/or audio mixer 108b is now further back in the production pipeline than the existing production truck model. By reprioritizing and centralizing the control, the data control system 100 is able to effectively coordinate the activities of all systems throughout the production pipeline.

The processing layer 108 may also include audio/video processing devices 108e. Audio/video processing devices may include frame synchronizers, color correction, cross conversion (HD to SD, SD to HD, HD to HD), audio embedders/de-embedders, audio delays, video delays, and the like. The audio/video processing devices 108e are in communication with the video and audio routers 108c and 108d and the video switcher 108a and audio mixer 108b. Also, a data processing device 108f can also be included in the processing layer 108. As shown in FIG. 1, the data processing device 108f is in communication with several data modules of the content layer 106. Once the data processing device receives and processes data from the content layer 106, the data processing device sends the processed data to the final data outputs in the delivery layer 110.

Some types of routing or switching hardware are required in the data control system 100 if it is necessary to change video sources from the UI. This can even be accomplished using the built in video inputs on new video input cards. The Matrox X.mio 8000 currently supports 2 SD/HD SDI inputs. One embodiment of the data control system 100 can operate on a strictly graphical mode with no video sources, which might include statistical or information screens. Typical applications of this may include information kiosks or large format LED (Light Emitting Diodes) screens.

A typical video router 108c (see FIG. 1) can change the mapping of a signal from where it originates (source), to where it leaves (destination). The number of sources and destinations can range from 2×2 up to 512×512, where the first number is the source/input and the second number is the destination/output. Additionally, it is not required that the amount of sources and destinations match.

Use of the video router 108c in one embodiment of the data control system 100 allows the flexibility to rapidly switch numerous video sources from software. Typical router configurations are stored as “Salvos” on many router panels. By saving these “Salvos” on the computer, the system is able to both manually and automatically route signals as needed. This type of functionality can be very helpful in failover situations when a device fails. Once detected, the data control system can send the necessary commands to route the signal to a backup device.

In other embodiments of the data control system 100, the system can support any combination of routers and switchers. It has also been contemplated that both devices will be incorporated to increase the functionality of the signal flow.

The video switcher 108a (see FIG. 1) can provide the basic functionality of a router, as well as additional video processing functionality. Some additional functionality from the video switcher may include the following: cross fades between video sources, transitions between video sources, re-positioning of video sources, displaying multiple video sources simultaneously, storing/recalling of pre-determined layouts (Emems), and specialized video effects, such as blurs, color correction, and lighting effects.

Video switchers are generally used for these advanced video processing features and are needed for advanced feature requirements during a broadcast. The switcher can also function as a video router but typically does not include the expandability of the router. A typical switcher might have 24-48 inputs with 2-24 outputs whereas a router can expand to 1024×1024 input/output and beyond. In one embodiment of the data control system 100, the switcher 108a is used sans the router 108c. In another embodiment, both the router and switcher are used as shown in FIG. 1. Still in another embodiment, the router may be used in the system sans the switcher.

Most switchers have the ability to scale and manipulate video sources. Grass Valley refers to this functionality as iDPM (internal Digital Picture Manipulator), and this functionality is also commonly referred to as DVE's (Digital Video Effect). If a switcher incorporates more than one DVE, a split screen effect can be created where two video sources are simultaneously displayed. Another common example of this is a “Picture in Picture” layout where a small window of video is placed within a larger video source. In the embodiment used for HotPass, the data control system 100 relies on this technology to accommodate the various multi-window displays required on this application. For other applications, such as a football game, the system might only utilize a single video source at full screen and therefore not need any type of DVE technology.

Some video switchers can add additional functionality that can be used within the data control system 100 environment, such as the following: clip store capability, ram store still and motion, pattern generators, and effects generators.

Audio mixers 108b, as shown in FIG. 1, provide the ability to manage multiple audio sources at the same time and create a blended audio stream that can be comprised of one or more sources. Embodiments of the data control system incorporate a mixing board that allows the user to control the levels and tone of all incoming sources at the same time. Presets can be used for specific scenarios to allow the operator to quickly jump to a specific setting. Using the same approach to video switching, this process can be automated via the data control system as long as the audio mixer 108b has the required interface ports (TCP/IP, Serial). Certain functionality found in newer audio mixing hardware is Digital Signal Processors (“DSP”). DSP's allow real-time manipulation of the audio signal. This could be used to limit the volume throughout a broadcast (audio limiter).

5. Delivery Layer

As shown in FIG. 1, the control layer 102 can access the delivery layer 110 via the communication layer 104. Also, the delivery layer 110 is in communication with the processing layer 108. The delivery layer 110 is responsible for the various output signals. This could include routing, alternate feeds, cross converting or any other various delivery formats. Because of the monolithic approach, the same amount of flexibility through the centralized control of all the devices is achieved. This allows tremendous flexibility for the following types of applications, including metadata tagging of audio/video signals, separate feeds for Web 2.0 delivery, localized graphics overlays for international broadcasters, and automated ad insertion.

There are three components 110a, 110b, and 110c to the delivery layer 110 as shown in FIG. 1. Final video outputs 110a depend on the broadcast requirements. Many times there are additional auxiliary feeds required by broadcasters to accommodate the different delivery mechanisms. Some of the various video feeds include program, split, auxiliary, localized, clean, web, and mobile. Additionally, there are no limits to the amount of feeds coming out of this embodiment of the data control system. Multiple screen installations can send the same signal to different displays, or completely different signals to each of the screens. These multi-display systems can accommodate the following applications, including, simultaneously driving a large format LED sign at a stadium and a ribbon board, simultaneously driving multiple screens at a concert venue, non-standard electronic signage, e.g., Times Square, digital billboards, multi-screen venues (LA-Live).

Final audio outputs 110b can be appropriately mixed as well to provide significant flexibility on the final delivery. Different audio mixes can be provided to the appropriate video sources to accommodate different languages, different sound effects, or any other requirements. Some of the various audio feeds include program, voice over (VO), effects, and localized.

Final data outputs 110c provide a synchronized stream of data that can be used for tagging purposes within the video or any other type of metadata that can be used with the production. Some of the various data feeds include time code, metadata tagging, event information, video information, location/GPS information, and camera information.

In one embodiment, the final video, audio, and data streams can be encrypted using well-known encryption technologies.

B. Hardware Examples

One embodiment of the data control system 100 may consist of the following hardware components:

1. The video switcher 108a can be the Kayak Switcher from Grass Valley.

2. High Definition (HD) Digital Distribution Amplifiers (DA) from Evertz are used, which can be located in the processing layer 108 as the audio/video processing.

3. Standard Definition (SD) Analog Distribution Amplifiers (DA) from Evertz are used, and also located in the audio/video processing box of the processing layer 108.

4. VIP 4 Multi Image Display Processor (MIDP) from Evertz is used.

5. VIP 12 Multi Image Display Processor (MIDP) from Evertz is used.

6. 5600 Master Sync and Clock Generator (MSC) from Evertz is used.

7. Control Systems used in this embodiment include:
Intel Dual Xeon 2.8 GHz processors
80 GB 10,000 RPM SATA HDD
4 GB RAM
NVIDIA FX5500 256 mb PCI
360W Power Supply
SuperMicro X5DPA-TGM+Motherboard, 800 MHz FSB
1U SuperMicro Chassis
2.5 DVD-ROM drive
Windows XP Pro SP2

8. Graphics Engines used in this embodiment include:
Intel (2) Quad Core 2.83 GHz Harptertown processors
80 GB 10,000 RPM SATA HDD
2 GB RAM
NVIDIA Quadro FX5600 PCI-e 16×1.5 GB memory
Matrox X.mio 8000 video input/output card PCI-X 133 MHz
Digigram Vx222 PCI audio card
Dual 800W redundant power supplies
SuperMicro X7DAL-E motherboard, 1333 FSB
4U SuperMicro Chassis
3.5 DVD-ROM drive
Windows XP Pro SP2

9. Servers used in this embodiment include:
Intel Xeon 2.8 GHz processors
a 320 GB 7200 RPM SATA HDD
2 GB RAM
NVIDIA FX5500 256 mb PCI
360W Power Supply
SuperMicro X5DPA-TGM+Motherboard, 800 MHz FSB
1U SuperMicro Chassis
2.5 DVD-ROM drive
Windows 2003 Server Enterprise Edition

10. Network, Netgear 8 port GigE switches are used in this system.

C. Operator Workflow

The data control system 100 streamlines the use and operation of systems required in television production. Standard broadcasts have become very complex and specialized that even a simple broadcast cannot be aired without numerous, highly skilled operators and support staff. This is because the fundamental approach to television production is based upon a distributed design.

The embodiments of the data control system 100 focus on the required functionality needed to produce a live production. Combined with the monolithic approach to system design, the embodiments of the data control system provide ease of use and sophisticated systems control for the operator.

D. Shift from Switcher to Graphics Engine

Traditionally, the video switcher has been the core of a broadcast. Most video devices, for example, reply, various types of cameras, commercials, and various types of graphics, will deliver a video signal(s) that ultimately get routed to the video switcher. All of the other content devices have been marginalized, because they are not as important as the video switcher. Switcher operators (TD's) traditionally get paid much more than graphics/replay/tape operators. This is because the video switcher is the one hardware device that a traditional broadcast needs to go on air.

One embodiment of the data control system 100 still can use a video switcher in a similar capacity; however, the workflow approach is quite different from traditional production. This system is able to consolidate the numerous devices or modules in the content layer 106, and therefore, this embodiment can control the graphic requirements much easier. Also, since the quantity of formerly disparate systems is now integrated into the graphics engine, the device becomes more important than the individual systems.

One embodiment of the data control system 100 re-prioritizes the graphics engine on the same level as the video switcher. The switcher operator is removed from his dedicated position at the switcher and now controls the control system 102d. The data control system allows much of the required functionality to the video switcher via a simple GUI (Graphical User Interface). Additionally, the system synchronizes and automates control of the graphics engine, as well as any other devices in the content layer 106.

Ultimately, the TD has the same fundamental responsibility, which is to change the incoming video sources and graphical elements necessary to produce a program. However, since the TD is now controlling these actions from a software based application, many of the secondary responsibilities can be automated that use to be handled by dedicated operators on proprietary systems. An example of this automation would be a sponsor logo embedded on various graphics as they are brought on to the screen.

E. Synchronized Operations

The centralized control system 100 allows far more complex synchronizing of the systems used during a production. One embodiment of the system incorporates an “event-based synchronizing” of various elements in a broadcast. Event based synchronizing allows much more complex events to occur during a broadcast.

An example of this is a traditional broadcast production that might use a wipe to switch between two feeds while removing a graphic element. During a wipe, there is typically a very short time frame (0.1 seconds) for any changes to occur. A switcher can trigger the video to change at that moment, but once you introduce additional devices, it becomes increasingly difficult to coordinate which elements are to be removed during the wipe, and which ones should appear after the wipe.

One embodiment of the data control system 100 can set up triggers to function in any of the following ways. The trigger can be manual, where the operator manually brings the graphic on/off via the control software. Also, the trigger can be event-based, such that the operator prepares an element (graphic, video, ad, layout, video source, and the like) and delegates the element to come on at the next trigger event (i.e., transition, time code, score, and the like). Further, the trigger can be event based trigger off, meaning that the operator delegates an active element (graphic, sponsor, ticker, layout, video source) to turn off at the next trigger event (i.e., transition, time code, score, and the like).

By combining the different event-based triggers, this embodiment of the system allows the user to gang up multiple pre/post event triggers that can facilitate a number of different graphics going on/off/changing during any instant in the broadcast. These groups of triggers can also be saved as presets in software.

Iv. Graphics Development

A. Template Based, Real-Time Platform

The use of a template based, real-time platform (see VizRT, www.vizrt.com) allows a significant amount of flexibility in the data control system 100. Graphic templates only need to be created once, and can be populated with data as needed for a broadcast. The current approach to broadcast graphics incorporates some type of computer graphics (“CG”) device for insert graphics. Insert graphics, a module found in the content layer 106, generally refers to graphics that are template based and dynamic. These systems provide specific functionality within the broadcast and generally require dedicated hardware as well as an operator. Typical insert graphics include any of the following: clock and score graphics (most sporting events), first and ten line (yellow first down line used in football), tickers, virtual graphic insertion (virtual jumbo-tron screen), ad insertion, and sponsored graphics.

B. Pre-Produced Graphics

Also found in the content layer 106 are pre-produced graphics, which are elements that are built in advance and typically stored on a tape or digital file format. These elements can include video, graphics, special effects, and audio. Once created, the pre-produced graphics typically cannot be updated and manipulated in real-time. Examples of pre-produced graphics include and of the following: transitions, opens/closes, bumps, teases, promos, billboard beds, and backgrounds.

C. Graphics

One embodiment of the data control system 100 uses a monolithic approach to the graphics delivery. Instead of using multiple systems and operators, this embodiment combines the required functionality into a single system. This approach provides the ease and ability to easily synchronize the operation of the various graphic requirements. A properly developed scene can include the following elements that traditionally need dedicated systems: looping backgrounds (DDR), ticker (dedicated graphics system), insert elements (dedicated graphics system), additional insert elements (dedicated graphics system), sponsorship (dedicated graphics system), and transitions (dual channel DDR).

Current on-air graphics systems build a single graphics template for each individual graphic in a standard insert package. One embodiment of the data control system integrates all the templates into a single scene. An additional advantage of this embodiment of the data control system 100 is that it can migrate pre-produced graphics to live graphic templates. This allows the user to easily change and customize the graphics as needed in the broadcast. An example of this might be a looping background animation that is specific to an NFL team. Currently, if each background is a 0:30 second loop, then 32 NFL teams would each need a custom pre-produced looping background. This background would also need to be played off a dedicated DDR (Digital Disk Recorder) and manually selected via the system's front end UI or a switcher. Using the template-based approach in the control data system 100, a single background scene can be created that would contain all the variables for team logo, colors, name, and the like. Simply selecting the appropriate team would automatically update all the required elements to make the template be specific to a particular team. Since this is integrated into the graphics engine, there is no storing of digital video files that would take up 3 GB (Gigabytes) per 0:30 second animation (assuming a resolution of 720p 59.94) for each team. The template description might be under 1 MB (Megabyte) yet accommodating numerous configurations. Also, disparate graphics are consolidated in the environment provided by the data control system 100.

D. Hardware Acceleration

The rapid growth of template-based graphics systems is due to dedicated hardware acceleration technology. Driven by the gaming industry, this acceleration technology is common in most computer systems. The latest Hardware Acceleration cards from NVidia (Quadro FX Family) have contributed to the consolidation of the different graphic elements in one embodiment of the data control system 100. In the past these cards were only capable of animating a single graphic element, but they can now store hundreds of graphics in a single scene. However, because the industry has evolved on the segregation of graphics systems as well as the segregation of individual graphic assets, the monolithic approach has not been used. Accordingly, production truck companies and broadcast networks are fighting a difficult battle trying to support various devices from different vendors with no central control.

E. Scene/Template Construction

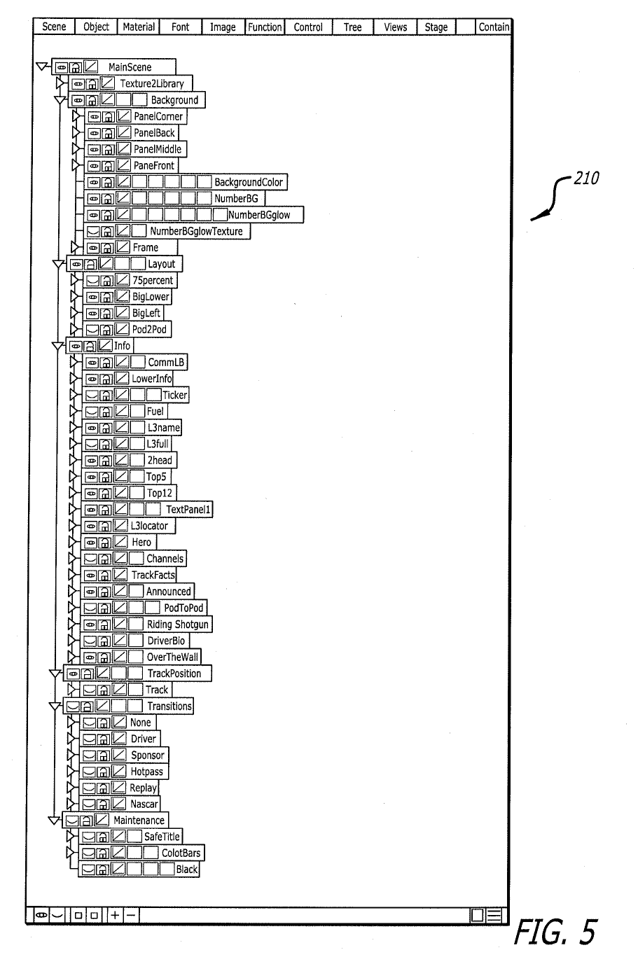

One embodiment of the data control system 100 applies a highly-organized structure when building the graphic templates for an application. An organized methodology is imperative since numerous types of content can be consolidated into the system logical. The elements are organized in a hierarchical format allowing the flexibility to add, remove, and modify the various elements in the scene as shown in FIG. 5, which is an example of a scene tree structure. The elements and scenes in the tree 210 may be pre-loaded before the broadcast.

Typical template construction would include a node at the highest layer of the hierarchy for each type of element. The elements can be seen in the content layer 106 as shown in FIG. 1, including virtual and robotic cameras, all types of commercials, graphics, localized languages, digital audio and sound effects. Additional elements of the same type would be grouped under their respective “Master Node”. Additional levels of organization can be used to further segregate the elements, for example, the elements could include the following levels: Scene/Insert Graphics/Full Screen Elements/Financial Data/Index Template. The insert graphics module in the content layer 106 is a “Master Node” and is the top-most level in the template hierarchy and would include elements from FIG. 1. The next level, Full Screen Elements, describes the general type of graphic being used. Other examples of insert graphics at this level could be lower thirds, over the shoulder (OTS), bugs, clock, and score. The next level, Financial Data, refers to the category of data being displayed. Other examples of categories could be Weather, Headlines, Breaking News, Sports Results, and many more. The final level in this example, index template, represents the specific type of graphic element under the category of data. Because it is an index template, it is assumed that the template can represent any type of financial indices. Other specific types of graphic elements on this level can include Stock Quote, Market Trends, Market Gainers/Market Looser, and the like.

The same methodology is used for the pre-produced graphics module in the content layer 106 as shown in FIG. 1. For traditional productions, pre-produced graphics are generally rendered linear animation that play back from a VTR or DDR. This is very inefficient because of the expensive hardware needed to deliver this content. Additionally, because the frames have been rendered to individual frames in a linear animation, there is little or no flexibility in changing these graphics without re-building them from the beginning. This process can take hours, or days, or event weeks depending on the complexity of the animation. As an example, to make 43 different backgrounds that each corresponded to a specific driver during a NASCAR race, an operator would need to render the animation 43 times.

In one embodiment of the data control system 100, the system builds the previously rendered animations in a dynamic template format. This is a new approach to graphics delivery. Not only does the data control system make animations more flexible, but it can now be integrated into the same Master scene template with the insert graphics module. As an example, because it is a template, there is no need to build 43 versions for each driver in a NASCAR race. The single template can accommodate any amount of variations for drivers, teams, races or anything else. This methodology can apply to any event.

The transition graphics module of the content layer 106 shown in FIG. 1, is another example where this approach leverages the data control system 100 and consolidates the control of the different devices. With a transition built in a proper template format, one embodiment of the data control system can have a transition that is specific to a driver, player, event, time of day, or anything else, all from a single template. Transitions require two synchronized video streams, a Fill channel and a Key channel, because transitions typically overlay the video. This requires twice the amount of storage space on a DDR for each channel. Additionally the channels must be frame accurate to ensure the Fill matches the Key exactly. These multi-channel DDR's are expensive, dedicated hardware. The graphics system of the data control system already provides a Fill and Key channel for any and all of the graphic elements within the template. Adding a transition element is simply another category of graphics in the scene, so there is no dedicated hardware.

Sponsored elements, such as virtual advertising and sponsorship modules in the content layer 106 as shown in FIG. 1 are another important aspect of live productions. Many times there are contractual agreements between the broadcaster and the sponsor as to exactly, how/when/how often a specific sponsor should be displayed and on which graphics. Many sponsorship and ad insertion systems are dedicated to this one task. In one embodiment of the data control system, sponsorship elements can be included in the Master Scene Template and can be automatically or manually trigged from the data control system. Other elements include pre-produced graphics, including opens, bumpers, commercials, promos, and localized languages.

V. Applications

In one embodiment, the data control system 100 is relatively small enough that it can fit into a much smaller footprint than traditional broadcasts, even forgoing the need for a dedicated transportation vehicle, and relying simply on flight packs that can be shipped. Due to the size of the data control system, it has been contemplated that the data control system can be permanently installed into a room at any venue, such as baseball, basketball, hockey, football, or soccer stadiums. This would eliminate the need to have a truck or van carrying the data control system to arrive at individual events. Still, in other embodiments, a small trailer or truck can be used to transport and set-up the data control system for live productions.

Vi. Other Uses

Although the data control system 100 has primarily been discussed with reference to the production of a sporting event, the data control system has several other possible uses. This system is also usable for any event using multiple sources of data, including multiple video feeds and graphics. However, the system can also be used for an event with one video feed. Some examples of other uses include studio programming, game shows, news programs, multiple channel events, localized channel events, medical applications, education applications including simulated broadcasts, corporate applications, religious applications, web casting, non-standard broadcast, concerts, surveillance, search and rescue missions, military exercises, exploration, scientific or other research, or the like.

While various embodiments have been described above, it should be understood that they have been presented by way of example only, and not by limitation. Thus, the breadth and scope of a preferred embodiment should not be limited by any of the above-described exemplary embodiments, but should be defined only in accordance with the following claims and their equivalents.

What is claimed:

1. A system for controlling the production of data, comprising:
a control layer including a computer and a user interface enabling an operator to control the production of data;
a content layer in communication with the control layer, the content layer providing video and graphical data, wherein the video and graphical data is accessible by the control layer;
a processing layer in communication with the control layer and the content layer, the processing layer capable of processing the video and graphical data from the content layer upon the command of the control layer; and
a delivery layer in communication with the control layer and the processing layer, the delivery layer delivering the final output of the video and graphical data upon the command of the control layer.

2. The system of claim 1, further comprising a communication layer in communication with the control layer, the communication layer providing a conduit for the control layer to access the content layer, the processing layer and the delivery layer.

3. The system of claim 2, wherein the communication layer is in communication with a server.

4. The system of claim 2, wherein the communication layer is in communication with an external communications link.

5. The system of claim 4, wherein the external communications link includes a wide area network link that connects the control layer to a third party providing live data.

6. The system of claim 1, wherein the control layer includes a remote control system with a remote user interface for a remote operator to control production of data.

7. The system of claim 1, wherein the control layer includes an automated control system with an automated user interface for an automated operator to control production of data.

8. The system of claim 1, wherein the user interface includes a touch screen.

9. The system of claim 1, wherein the content layer provides audio data or live data.

10. The system of claim 1, wherein the processing layer includes a video router.

11. The system of claim 10, wherein the processing layer includes a video switcher.

12. The system of claim 1, wherein the processing layer includes a video switcher.

13. The system of claim 1, wherein the processing layer includes a video/audio/data processing device, an audio mixer, an audio router, and a data processing device.

14. The system of claim 1, wherein the delivery layer delivers the final video output for a live broadcast.

15. The system of claim 1, wherein the data control system synchronizes disparate devices located in the content layer and processing layer.

16. The system of claim 1, wherein the control layer controls disparate devices located in the content layer and processing layer.

17. The system of claim 1, wherein the content layer includes a localized language device for displaying data in a specific language.

18. The system of claim 1, wherein the graphic data is template based.

19. A method for producing a program using a computer system, comprising:
providing sources of video and graphical content from at least one module;
synchronizing the video and graphical content with a processing device;
delivering the video and graphical content through a final video output for production into a live broadcast; and
controlling the synchronizing of the video and graphical content via a centralized control system that is in communication with the at least one module providing the video and graphical content, the processing device, and the video output.

20. The method of claim 19, wherein providing video and graphical content from live camera feeds and pre-produced graphic templates.

21. The method of claim 19, further comprising providing live data to be synchronized with the video and graphical content.

22. The method of claim 19, wherein the processing device is a video router or a video switcher.

23. The method of claim 19, wherein controlling the synchronizing of the video and graphical content, the centralized control system is in communication with a network communication system that is in communication with the sources of the video and graphical content, the processing device, and the video output.

24. The method of claim 19, further comprising providing a local language feed and synchronizing the local language feed with the video and graphical data.

25. The method of claim 19, further comprising providing live data and synchronizing the live data with the video and graphical data.

26. The method of claim 25, wherein synchronizing the live data with the video and graphical data, the live data is added into a template.

27. A system for controlling the production of data for a broadcast, comprising:
a control computer including a user interface for an operator to control the production of data, the control computer in communication with a network;
a video module providing video content, the control computer is in communication with the video module via the network; and
a video mixer in communication via the network with the video module and the control computer through the network, and wherein the control computer synchronizes the video content by controlling the video mixer to produce the broadcast.

28. The system of claim 27, further comprising an audio module providing audio content in communication with the control computer through the network.

29. The system of claim 28, further comprising an audio mixer in communication with the audio module and in communication with the control computer through the network, and the control computer synchronizes the video content and audio content by controlling the video mixer and audio mixer.

30. The system of claim 27, further comprising a graphics module providing graphical content in communication with the control computer through the network, and the graphics module is in communication with the video mixer.

31. The system of claim 30, wherein the control computer synchronizes the video content and graphical content by controlling the video mixer.

32. The system of claim 30, wherein the graphical content includes pre-produced graphic templates.

33. The system of claim 28, wherein the video content includes content from a live camera feed.

34. The system of claim 28, wherein the user interface of the control computer is capable of allowing the operator to input live data to synchronize with the video content.
